(19) United States
(12) Patent Application Publication
(10) Pub. No.: US 2024/0142056 A1
(43) Pub. Date: May 2, 2024

(54) HIGH-PRESSURE TANK

(71) Applicant: TOYOTA JIDOSHA KABUSHIKI KAISHA, Toyota-shi (JP)

(72) Inventor: Naoki OGIWARA, Nagoya-shi (JP)

(73) Assignee: TOYOTA JIDOSHA KABUSHIKI KAISHA, Toyota-shi (JP)

(21) Appl. No.: 18/448,275

(22) Filed: Aug. 11, 2023

(30) Foreign Application Priority Data
Oct. 27, 2022 (JP) 2022-172482

(51) Int. Cl. F17C 5/00; F17C 1/06

(52) U.S. Cl. CPC F17C 5/00; F17C 1/06; F17C 2201/0109; F17C 2201/035; F17C 2201/054; F17C 2203/012; F17C 2203/0604; F17C 2203/0619; F17C 2203/0643; F17C 2203/0646; F17C 2203/066; F17C 2203/0673; F17C 2205/0335; F17C 2221/012; F17C 2260/02

(57) ABSTRACT

A tank arranged such that an axis is horizontal, and filling portions are arranged at both ends in the axial direction, and both filling portions are configured to inject gas toward an upper portion of an inside of the tank.

### CROSS-REFERENCE TO RELATED APPLICATION

This application claims priority to Japanese Patent Application No. 2022-172482 filed on Oct. 27, 2022, incorporated herein by reference in its entirety.

### BACKGROUND

### 1. Technical Field

The present disclosure relates to a high-pressure tank.

### 2. Description of Related Art

Japanese Unexamined Patent Application Publication No. 2003-267069 (JP 2003-267069 A) discloses providing an inclination in a filling port of a one-side filling type high-pressure tank.

### SUMMARY

In the case of a double-side filling type high-pressure tank, the conventional means cannot be applied because the flow of gas in the tank is different from that of the one-side filling type high-pressure tank.

An object of the present disclosure is to provide a high-pressure tank capable of improving the stirring performance in the tank for double-side filling.

The present application discloses a high-pressure tank. The high-pressure tank is a tank disposed such that its axis is horizontal. A filling portion is disposed at each of both ends in an axial direction. Each of the filling portions is configured to inject gas toward an upper portion of an inside of the tank.

The filling portion may be provided with a check valve.

A tank length of the tank may be equal to or greater than 2100 mm.

A direction of injecting the gas may be a direction toward an uppermost inner wall surface at a center of the tank in a longitudinal direction.

According to the present disclosure, it is possible to improve the stirring performance in the tank regardless of the tank length for double-side filling.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an external view of a high-pressure tank 10;

FIG. 2 is a cross-sectional view along the axis of the high-pressure tank 10;

FIG. 3 is an enlarged view of a portion of FIG. 2;

FIG. 4 is a diagram illustrating an example of a flow in a tank;

FIG. 5A is a diagram illustrating a gas-injection method according to an embodiment;

FIG. 5B is a diagram illustrating an embodiment of a gas-injection system according to a comparative embodiment;

FIG. 5C is a diagram illustrating an embodiment of the gas-injection in another comparative example; and

FIG. 5D is a diagram for explaining the aspect of the gas-injection in another comparative example.

### DETAILED DESCRIPTION OF EMBODIMENTS

### 1. Structure of the High-Pressure Tank

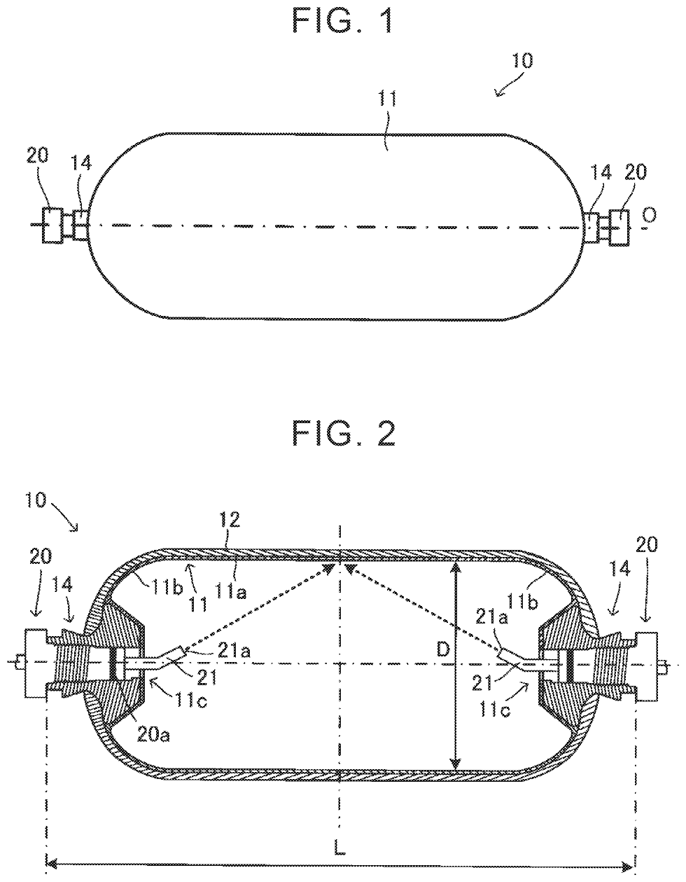

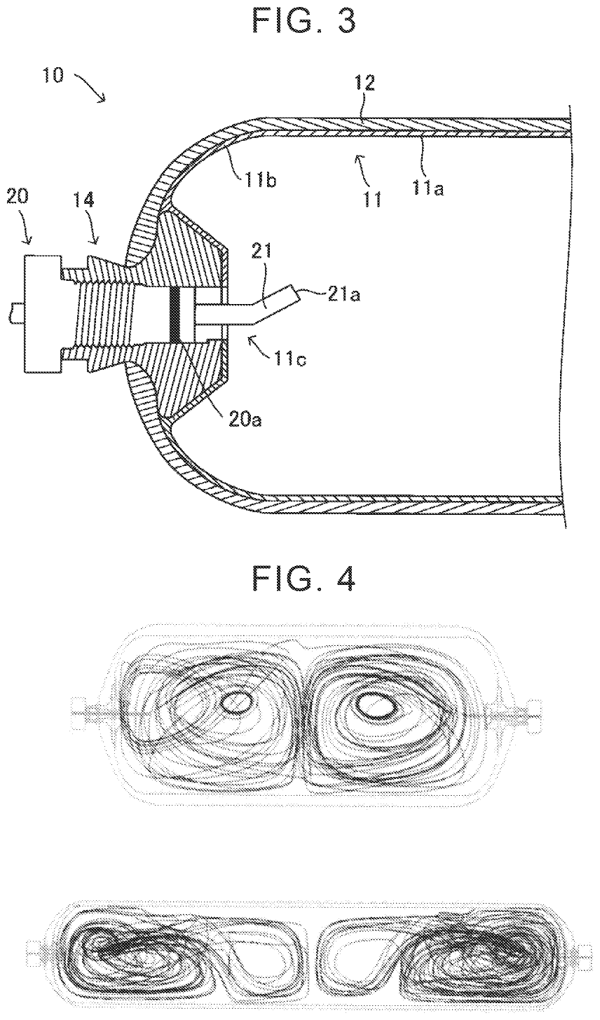

FIG. 1 schematically illustrates the appearance of a high-pressure tank 10 according to one embodiment, FIG. 2 is a cross-section taken along the axis O of the high-pressure tank 10, and FIG. 3 is an enlarged view of the left half of the total length L of the high-pressure tank 10 along the axis O in FIG. 2. As can be seen from these figures, in the present embodiment, the high-pressure tank 10 includes a liner 11, a reinforcing layer 12, a base 14, and a valve 20. Each configuration will be described below.

### 1.1. Liner

The liner 11 is a hollow member that partitions the internal space of the high-pressure tank 10, and is cylindrical in this embodiment. In the liner 11, the opening at both ends of the body portion 11a having a substantially constant diameter is narrowed by the dome-shaped side end portion 11b, and the base 14 is disposed in the narrowed opening 11c.

The liner 11 may be made of a material capable of holding the material contained in the internal space (for example, hydrogen) without leaking, and a known material may be used as the material. Specifically, it is made of, for example, a nylon resin, a polyethylene-based synthetic resin, or a metal such as stainless steel or aluminum. Among them, from the viewpoint of weight reduction of the high-pressure tank, the material constituting the liner is preferably a synthetic resin.

The thickness of the liner 11 is not particularly limited, but is preferably 3.0 mm from 0.5 mm. The inner diameter of the liner 11 indicated by D shown in FIG. 2 is not particularly limited, but may be about 800 mm from 300 mm.

### 1.2. Reinforcing Layer

In the reinforcing layer 12, fibers are laminated over a plurality of layers, and the fibers are impregnated with a cured resin. The fiber layer is formed by winding a fiber bundle over a plurality of layers up to a predetermined thickness around the outer periphery of the liner 11. The thickness of the reinforcing layers 12 and the number of turns of the fiber bundle are not particularly limited because they are determined by the required strength, but are 30 mm from 10 mm.

### Fiber Bundle

For example, carbon fiber is used as the fiber bundle of the reinforcing layer 12. The fiber bundle has a band shape having a predetermined cross-sectional shape (for example, a rectangular cross-section) as a bundle of carbon fibers. Although not particularly limited, the cross-sectional shapes may be rectangles having 6 mm to 20 mm widths and 0.1 mm to 0.3 mm thicknesses. The amount of the carbon fiber contained in the fiber bundle is not particularly limited, but may be, for example, about 36000 carbon fibers.

### Impregnated Resin

The resin impregnated and cured in the fiber (fiber bundle) in the reinforcing layer 12 is not particularly limited as long as it can increase the strength of the fiber. Examples thereof include thermosetting resins which are cured by heat, and specific examples thereof include an amine-based or anhydride-based curing accelerator, an epoxy resin containing a rubber-based reinforcing agent, and an unsaturated polyester resin. In addition, a resin composition having an epoxy resin as a main agent and being cured by mixing the main agent with a curing agent can also be included. According to this, the resin composition, which is the mixture, reaches and permeates the fiber layer between the time when the main agent and the curing agent are mixed and the time when the mixture is cured, so that the mixture is automatically cured.

### 1.3. Protective Layer

If necessary, a protective layer may be disposed on the outer periphery of the reinforcing layer. When provided, for example, glass fibers are wound and impregnated with resin. The impregnated resin can be considered similar to the reinforcing layer 12. Thus, impact resistance can be imparted to the high-pressure tank 10.

The thickness of the protective layers is not particularly limited, but may be about 1.5 mm from 1.0 mm.

### 1.4. Base

The base 14 is a member attached to each of the two opening 11c of the liner 11, and is disposed at each of both ends in the axis O of the liner 11, and functions as an opening for communicating the inside and the outside of the high-pressure tank 10, and the valve 20 is attached thereto. Accordingly, the base 14 is provided with a hole having a circular cross section for placing the valve 20. The inner surface of the hole has an internal thread corresponding to the male thread of the valve. The female screw is combined with the male screw of the valve to fix the valve 20 to the base 14. Further, the inner surface of the hole has a sealing surface which is a smooth surface on the tank inner side (high pressure side) of the female screw. The seal member provided on the outer periphery of the valve is brought into contact with the seal surface, and the inside of the high-pressure tank 10 is airtight (sealed).

The member constituting the base 14 is not particularly limited as long as it has the necessary strength, and examples thereof include copper, iron, aluminum, and the like.

Here, the length (total length) of the high-pressure tank 10 in the direction of the axis O is the distance between the outer sides of the two bases 14 as illustrated by L in FIG. 2. The size of the L is not particularly limited, but may be 1500 mm to 3000 mm.

### 1.5. Valve

The valve 20 is held in a hole of the base 14 so as to pass the inside and outside of the high-pressure tank 10, and a filling pipe 21 forming a filling portion is arranged. The valve 20 is arranged in each of two bases 14 provided at both ends in the longitudinal direction of the high-pressure tank 10.

The valve 20 has a shaft portion disposed inside a hole of the base 14. The valve 20 is provided on the outer peripheral surface of the shaft portion with a male screw that is combined with the female screw of the base. As a result, the valve 20 is fixed to the hole of the base 14. Further, a seal member 20a is disposed on the outer peripheral surface of the valve 20, and the seal member 20a is disposed so as to be contacted with the seal surface of the inner surface of the bore, so as to be airtight (sealed).

The filling pipe 21 is a pipe and communicates with the inside of the high-pressure tank 10 from the outside. Thus, the filling pipe 21 has an open end inside the liner 11, which serves as an injection port 21a. Here, the injection port 21a of the filling pipe 21 is configured such that the injected gases are in a predetermined direction. Although a specific embodiment for this purpose is not particularly limited, for example, as shown in FIGS. 2 and 3, the tips including the injection port 21a are bent to be oriented.

Further, the filling pipe 21 may be provided with a check valve. When the check valve is used, the pressure loss increases, which causes a problem of lowering the filling efficiency of the gas, but according to the present disclosure, it is possible to increase the efficiency by simultaneously filling the gas from the two filling pipes 21 provided at both ends of the high-pressure tank.

### 2. Mode of Filling the High-Pressure Tank

The high-pressure tank 10 described above has a posture in which the axis O thereof faces in the horizontal direction when the gas is filled. It is not required to be exactly horizontal, and a range of ±15° from the horizontal direction is allowed.

The high-pressure tank 10 is filled with gases from both of the injection port 21a of the two filling pipes 21 into the liner 11. At this time, the direction in which the gas is injected is injected toward the upper portion as indicated by a dotted arrow in FIG. 2. Among them, it is preferable that the direction in which the gas is injected is directed toward the uppermost portion of the inner wall surface at the center in the longitudinal direction of the high-pressure tank 10 (a position half the total length L).

FIG. 4 shows the simulation results of the gas flow line after the gas injection. The upper view of FIG. 4 shows an example in which the total length L of the high-pressure tank is 2000 mm, the inner diameter D is 650 mm, the lower view of FIG. 4 shows an example in which the total length L of the high-pressure tank is 2500 mm, and the inner diameter D is 500 mm. In this simulation, the direction in which the gas is injected is an example directed toward the uppermost inner wall surface at the center in the longitudinal direction of the high-pressure tank 10 (the position at half the total length L).

By injecting the gas in this manner, the flow lines collide with each other at the center of the tank, and a small tank is formed on the left and right with the center interposed therebetween, thereby improving the stirring performance. As a result, high stirring performance can be obtained even at the end of filling. That is, the gas injected from the injection port 21a collides with each other, so that the gas flow is divided into two tanks, and the stirring performance is improved.

Further, the filling efficiency can be increased by filling the gas from the two filling portions in this way, it is possible to fill sufficiently efficient even by using a check valve having a large pressure loss. In particular, when the filling portion is one, when a large high-pressure tank such that the total length exceeds 2100 mm, hot gas is accumulated in the upper portion of the tank end opposite to the injection port, there is a possibility that the liner guaranteed temperature is exceeded, by filling the gas from the two filling portions as in the present embodiment, it is possible to solve such a problem.

### 3. Examples

In the examples, the orientation of the two gas jets was changed and the filling performance was examined by simulation.

Two types of high-pressure tanks were used. The total length L of the “short tank” was 2000 mm, the inner diameter D was 650 mm, the total length L of the “long tank” was 2500 mm, and the inner diameter D was 500 mm. In both cases, the high-pressure tank is in a horizontal position in the direction of its axis, and the gas is injected from both ends of the high-pressure tank in the axial direction toward the inside of the high-pressure tank.

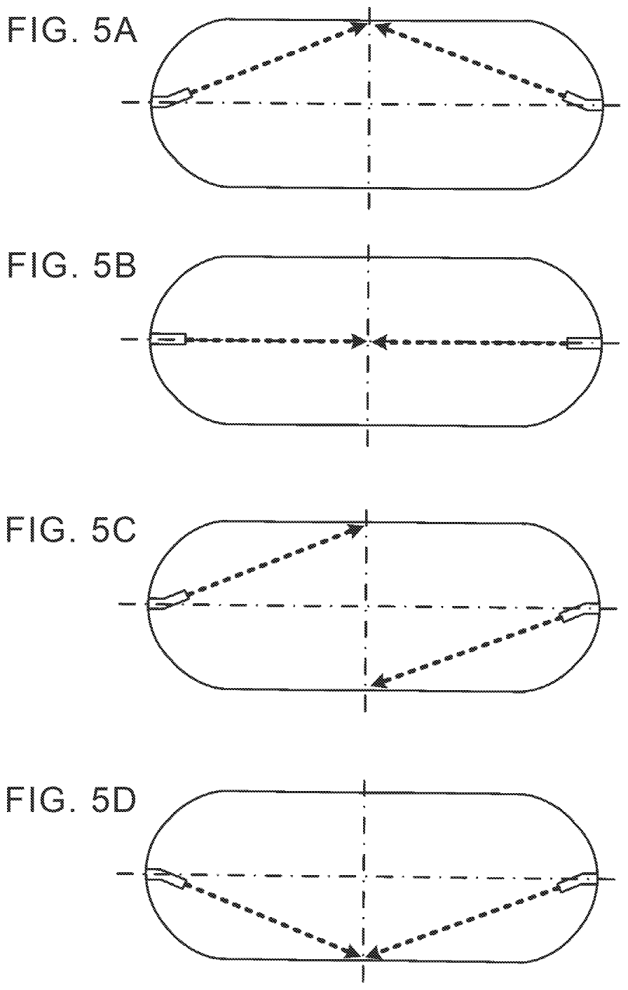

In the first embodiment, two jets are directed to the inner surface of the longitudinally central uppermost portion of the high-pressure tank as shown in FIG. 5A. In Comparative Example 1, two jets were leveled so as to face each other as shown in FIG. 5B.

In Comparative Example 2, as shown in FIG. 5C, the left injection was directed toward the inner surface of the uppermost central portion in the longitudinal direction of the high-pressure tank, and the right injection was directed toward the inner surface of the lowermost central portion in the longitudinal direction of the high-pressure tank.

In Comparative Example 3, as shown in FIG. 5D, two jets were directed toward the inner surface of the lowermost longitudinal center of the high-pressure tank.

Evaluation was based on the streamlines and temperature contours as shown in FIG. 4 as a result of the simulation to determine the quality of the stirring performance. Here, the quality of the stirring performance was determined from two viewpoints. In the first aspect, in the high-pressure tank 10, since the temperature sensor is disposed in the vicinity of the base 14 inside the liner 11, it is determined whether the temperature in the vicinity of the base is close to the average temperature in the tank. If the temperature is high in the vicinity of the base (the part where the temperature sensor is disposed), overfilling may occur. The second aspect was determined by the difference between the maximum temperature and the average temperature inside the liner 11. If the temperature difference is large when the filling is completed at the average temperature, the temperature is locally increased, it is possible to damage the liner exceeds the guaranteed temperature of the liner, this temperature difference is preferably small.

The results are as follows.

In Example 1, as described above for both the short tank and the long tank, the respective flow lines collided with each other at the center of the tank, and a small tank was formed on the left and right by dividing the flow lines into two at the center, so that the stirring performance was good. As a result, high stirring performance was obtained even at the end of filling. Specifically, in the first aspect, the temperature in the vicinity of the base was close to the average temperature, and in the second aspect, the temperature difference was 0.8° C. in the short tank and 1.4° C. in the long tank, which was smaller than in the other examples.

In Comparative Example 1, in both the short tank and the long tank, the flow velocity toward the tank upper side was low, high-temperature gas accumulation occurred in the upper portion near the boundary between the body portion and the side portion, and the stirring performance was lower than that in Example 1. Specifically, in the first aspect, the temperature in the vicinity of the mouthpiece is higher than the average temperature, the temperature difference in both the short tank and the long tank was 2.0° C. in the second aspect.

In Comparative Example 2, a relatively high stirring performance could be obtained for the short tank, but for the long tank, the propulsive force to the end portion was insufficient, and the gas injected downward flowed to the upper portion in the vicinity of the center of the tank, and the stirring performance was lower than that of Example 1 due to the generation of a high-temperature gas accumulation in the upper portion in the vicinity of the boundary between the body portion and the side portion. Specifically, for the first aspect, the temperature of the vicinity of the mouthpiece became close to the average temperature, the temperature difference in the short tank 1.4° C. in the second aspect, the temperature difference was larger than in Example 1 was 1.6° C. in the long tank.

In Comparative Example 3, cold gas was discharged to the lower portion of the tank for both the short tank and the long tank, and the hot gas remained accumulated on the upper side of the tank, so that a high-temperature gas accumulation occurred at the upper portion, and the stirring performance was lower than that of Example 1. Specifically, in the first aspect, the temperature in the vicinity of the base was higher than the average temperature, and in the second aspect, the temperature difference was 1.75° C. in the short tank and 1.70° C. in the long tank.

What is claimed is:

1. A high-pressure tank disposed such that its axis is horizontal, wherein
a filling portion is disposed at each of both ends in an axial direction, and
each of the filling portions is configured to inject gas toward an upper portion of an inside of the tank.

2. The high-pressure tank according to claim 1, wherein the filling portion is provided with a check valve.

3. The high-pressure tank according to claim 1, wherein a tank length of the tank is equal to or greater than 2100 mm.

4. The high-pressure tank according to claim 1, wherein a direction of injecting the gas is a direction toward an uppermost inner wall surface at a center of the tank in a longitudinal direction.
